(19) United States
(12) Patent Application Publication
(10) Pub. No.: US 2023/0385495 A1
(43) Pub. Date: Nov. 30, 2023

(54) EFFICIENT CIRCUIT SIMULATION METHOD AND APPARATUS, DEVICE, AND STORAGE MEDIUM

(71) Applicant: BATELAB CO., LTD., Suzhou (CN)

(72) Inventor: Zhen Li, Suzhou (CN)

(21) Appl. No.: 18/027,358

(22) PCT Filed: Jun. 1, 2022
(86) PCT No.: PCT/CN2022/096656

§ 371 Date: Mar. 20, 2023

(30) Foreign Application Priority Data
Aug. 9, 2021 (CN) 202110906086.4

(51) Int. Cl. G06F 30/331

(52) U.S. Cl. CPC G06F 30/331; G06F 2111/02

(57) ABSTRACT

This application relates to the field of electric digital data processing, and specifically to an efficient circuit simulation method and apparatus, a device, and a storage medium. The method includes: obtaining sub-circuit modules in a target circuit; performing function fitting processing on the sub-circuit modules to obtain fitting functions corresponding to the sub-circuit modules; and replacing, based on a logical relationship among the sub-circuit modules, the target circuit with the fitting functions respectively corresponding to the sub-circuit modules for simulation processing to obtain a simulation result of the target circuit. According to the foregoing solution, the target circuit is replaced with the fitting functions corresponding to the sub-circuit modules to perform simulation, a target circuit matrix with complex data does not need to be constructed, and the simulation efficiency of the circuit is improved.

### CROSS REFERENCE TO RELATED APPLICATIONS

This application claims priority to Chinese patent application No. 202110906086.4, entitled “CIRCUIT SIMULATION METHOD AND APPARATUS, DEVICE, AND STORAGE MEDIUM”, filed with the China National Intellectual Property Administration on Aug. 9, 2021, the disclosure of which is hereby incorporated by reference in its entirety.

### TECHNICAL FIELD

This application relates to the field of electric digital data processing, and specifically to an efficient circuit simulation method and apparatus, a device, and a storage medium.

### BACKGROUND

During circuit design, after completing the circuit design, an engineer usually needs to simulate a designed circuit with circuit simulation software to verify the correctness of the designed circuit.

After completing the circuit design, the engineer may input information of the designed circuit into the circuit simulation software. The circuit simulation software identifies circuit diagram information of the engineer, obtains type information, parameter information, and connection relationships between components in the circuit diagram information, and constructs an operation matrix corresponding to the circuit. The operation matrix may use a simulated circuit diagram to process an input signal and simulate an output signal of the circuit.

In the foregoing solution, when the circuit is large and includes a large number of circuit parameters, the constructed operation matrix is complex and the simulation efficiency of the circuit is low.

### SUMMARY

This application provides a circuit simulation method and apparatus, an electronic device, and a storage medium, to improve the simulation efficiency of a circuit.

According to an aspect, embodiments of this application provide a circuit simulation method. The method includes:
obtaining sub-circuit modules in a target circuit;
performing function fitting processing on the sub-circuit modules to obtain fitting functions corresponding to the sub-circuit modules; and
replacing, based on a logical relationship among the sub-circuit modules, the target circuit with the fitting functions respectively corresponding to the sub-circuit modules for simulation processing to obtain a simulation result of the target circuit.

According to another aspect, embodiments of this application provide a circuit simulation apparatus. The apparatus includes:
a sub-circuit obtaining module, configured to obtain sub-circuit modules in a target circuit;
a fitting processing module, configured to perform function fitting processing on the sub-circuit modules to obtain fitting functions corresponding to the sub-circuit modules; and
a simulation processing module, configured to replace, based on a logical relationship among the sub-circuit modules, the target circuit with the fitting functions respectively corresponding to the sub-circuit modules for simulation processing to obtain a simulation result of the target circuit.

In a possible implementation, the fitting processing module includes:
a simulation result obtaining unit, configured to obtain a simulation result of each of the sub-circuit modules; and
a fitting function obtaining unit, configured to: when a confirmation operation for the simulation result of any one of the sub-circuit modules is received, perform the function fitting processing on this one of the sub-circuit modules to obtain the fitting function corresponding to this one of the sub-circuit modules.

In a possible implementation, the sub-circuit obtaining module includes:
a candidate simulation obtaining module, configured to obtain a simulation result of a candidate sub-circuit module, where the candidate sub-circuit module is an unverified sub-circuit module for the target circuit; and
a sub-circuit determining module, configured to: when a confirmation operation for the simulation result of the candidate sub-circuit module is received, determine the candidate sub-circuit module as a sub-circuit module in the target circuit; and
the fitting processing module is further configured to:

when a simulation operation for the target circuit is received, perform the function fitting processing on the sub-circuit modules to obtain the fitting functions corresponding to the sub-circuit modules.

In a possible implementation, the fitting processing module is further configured to:
obtain sub-circuit parameters of each of the sub-circuit modules, and construct, based on the sub-circuit parameters, a sub-circuit matrix corresponding to each of the sub-circuit modules;
process sample input data based on the sub-circuit matrix to obtain predicted output data corresponding to the sample input data; and
perform fitting by using a linear regression method based on the sample input data and the predicted output data corresponding to the sample input data to obtain the fitting function corresponding to each of the sub-circuit modules.

In a possible implementation, the fitting processing module further includes:
a data range obtaining unit, configured to obtain an input data range corresponding to the sub-circuit matrix; and
an input data sampling unit, configured to perform sampling within the input data range corresponding to the sub-circuit matrix to obtain the sample input data.

In a possible implementation, the input data sampling unit further includes:
a matrix order obtaining sub-unit, configured to obtain a matrix order corresponding to the sub-circuit matrix; and
an input data obtaining sub-unit, configured to: equally divide the input data range based on the matrix order of the sub-circuit matrix, and determine data values obtained by the equal dividing as the sample input data.

In a possible implementation, the simulation processing module includes:
a first output unit, configured to process input data corresponding to an i^{th} sub-circuit module by using a fitting function corresponding to the i^{th} sub-circuit module to obtain output data corresponding to the i^{th} sub-circuit module, where the i^{th} sub-circuit module and an (i+1)^{th} sub-circuit module have a logical connection relationship; and
a second output unit, configured to process, by using a fitting function corresponding to the (i+1)^{th} sub-circuit module, the output data corresponding to the i^{th} sub-circuit module as input data corresponding to the (i+1)^{th} sub-circuit module to obtain output data corresponding to the (i+1)^{th} sub-circuit module.

According to still another aspect, embodiments of this application provide an electronic device, where the electronic device includes a processor and a memory, the memory stores at least one instruction, and the at least one instruction is configured to be loaded and executed by the processor to implement the foregoing circuit simulation method.

According to still another aspect, embodiments of this application provide a computer-readable storage medium storage medium stores at least one instruction, and the at least one instruction is configured to be loaded and executed by a processor to implement the foregoing circuit simulation method.

According to still another aspect, a computer program product or a computer program is provided. The computer program product or the computer program includes computer instructions. The computer instructions are stored in a computer-readable storage medium. A processor of an electronic device reads the computer instructions from the computer-readable storage medium. The processor executes the computer instructions, so that the electronic device is enabled to perform the foregoing circuit simulation method.

The technical solution provided in this application may include the following beneficial effects:

When simulation needs to be performed on a target circuit, the target circuit may be first divided into sub-circuit modules, and fitting is performed on the sub-circuit modules by using fitting functions, to implement representation of circuit characteristics of the sub-circuit modules by using the fitting functions. After the fitting functions corresponding to the sub-circuit modules in the target circuit are obtained, based on a logical relationship among the sub-circuit modules, the target circuit is replaced with the fitting functions corresponding to the sub-circuit modules to perform simulation, a target circuit matrix with complex data does not need to be constructed, and the simulation efficiency of the circuit is improved.

### BRIEF DESCRIPTION OF DRAWINGS

To describe the technical solutions in specific embodiments of this application or the prior art more clearly, the following briefly introduces the accompanying drawings required for describing the specific embodiments or the prior art. Apparently, the accompanying drawings in the following description show some embodiments of this application, and a person of ordinary skill in the art may still derive other drawings from these accompanying drawings without creative efforts.

FIG. 1 is a schematic structural diagram of a circuit simulation system according to an exemplary embodiment;

FIG. 2 is a method flowchart of a circuit simulation method according to an exemplary embodiment;

FIG. 3 is a method flowchart of a circuit simulation method according to an exemplary embodiment;

FIG. 4 is a method flowchart of a circuit simulation method according to an exemplary embodiment;

FIG. 5 is a schematic flowchart of a circuit design and a circuit simulation method according to an exemplary embodiment;

FIG. 6 is a structural block diagram of a circuit simulation apparatus according to an exemplary embodiment; and

FIG. 7 is a structural block diagram of an electronic device according to an exemplary embodiment of this application.

### DETAILED DESCRIPTION

The following clearly and completely describes the technical solutions in this application with reference to the accompanying drawings. Apparently, the embodiments described below are some embodiments of this application rather than all the embodiments. All other embodiments obtained by a person of ordinary skill in the art based on embodiments of this application without creative efforts shall fall within the protection scope of this application.

It should be understood that the “indication” referred to in embodiments of this application may be a direct indication, an indirect indication, or an indication of an association. For example, when A indicates B, it may mean that A indicates B directly, for example, B is available through A; it may also mean that A indicates B indirectly, for example, A indicates C and B is available through C; and it may also mean that there is an association between A and B.

In the description of embodiments of this application, the term “correspondence” may indicate a direct correspondence or indirect correspondence between the two, or may indicate an association between the two, or may be a relationship of indicating and being indicated, configuring and being configured, and the like.

In embodiments of this application, “predefined” can be implemented by pre-saving corresponding code, tables or other means that can be used to indicate related information in a device (for example, including a terminal device and a network device), and this application is not limited to a specific implementation thereof.

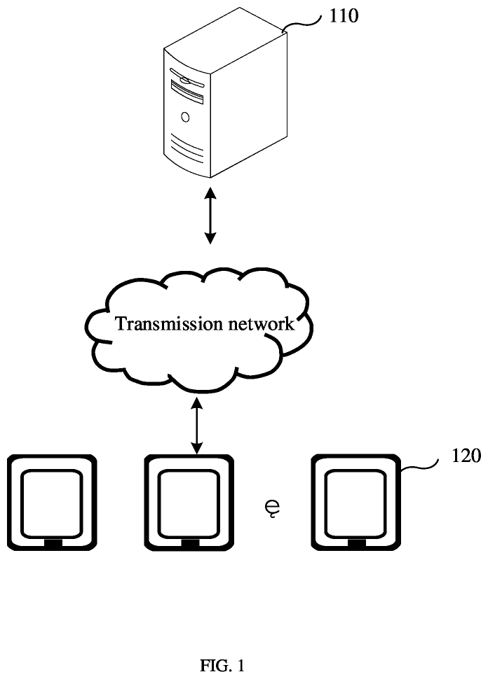

FIG. 1 is a schematic structural diagram of a circuit simulation system according to an exemplary embodiment. The circuit simulation system includes a server 110 and a terminal 120.

Optionally, the terminal 120 includes a circuit design client. When receiving a circuit design operation triggered by a user, the circuit design client in the terminal 120 may generate corresponding circuit data based on the circuit design operation triggered by the user.

Optionally, after the circuit design client in the terminal 120 generates the circuit data and a confirmation operation of a user client is received, the circuit data is transmitted to the server 110 and is stored in a data memory of the server 110, to subsequently perform simulation on a circuit structure indicated by the circuit data.

Optionally, the terminal 120 may receive, in a wired or wireless transmission manner, circuit data sent by another terminal, and store the circuit data in a data memory of the terminal 120. When the circuit design client in the terminal 120 receives a storage operation triggered by the user, the circuit data is sent and stored in the data memory of the server 110.

Optionally, the terminal 120 may be a data processing device such as a PC, a notebook, or an intelligent mobile terminal that has a high-performance processor.

Optionally, when the terminal 120 stores circuit data, after a simulation operation triggered by the user is received, simulation processing may be performed on the circuit data, and then a simulation result is sent and stored in the server 110.

Optionally, the foregoing server may be an independent physical server, or may be a server cluster or a distributed system formed by a plurality of physical servers, or may be a cloud server providing technical cloud computing services such as cloud services, cloud databases, cloud computing, cloud functions, cloud storage, network services, cloud communication, middleware services, domain name services, security services, content delivery networks (CDNs), and big data and artificial intelligence platforms.

Optionally, the system may further include a management device. The management device is configured to manage the system (for example, managing the connection status between modules and the server). The management device is connected to the server by a communication network. Optionally, the communication network is a wired network or a wireless network.

Optionally, the foregoing wireless network or wired network uses standard communication technologies and/or protocols. The network is usually the Internet, or may be any other network, including, but not limited to, any combination of local area networks, metropolitan area networks, wide area networks, mobile, limited or wireless networks, private networks, or virtual private networks. In some embodiments, technologies and/or formats including hypertext markup languages, extensible markup languages, and the like are used to represent data exchanged over the network. Conventional encryption techniques such as Secure Sockets Layer, Transport Layer Security, Virtual Private Network, InterNetworking Protocol Security, and the like may also be used to encrypt all or some links. In some other embodiments, custom and/or private data communication techniques may be used instead of or in addition to the foregoing data communication techniques.

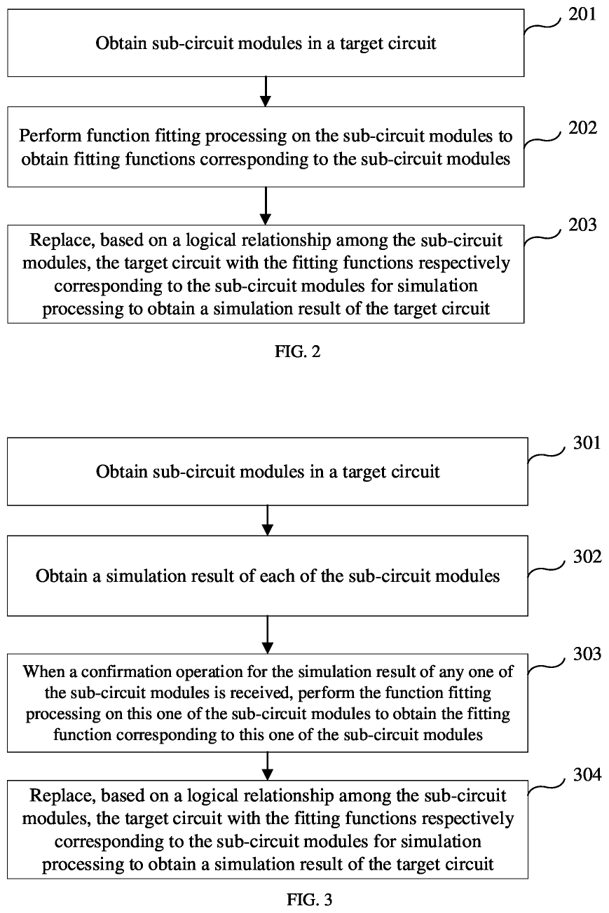

FIG. 2 is a method flowchart of a circuit simulation method according to an exemplary embodiment. The method is performed by an electronic device. The electronic device may be the server 110 in the circuit simulation system shown in FIG. 1 or the terminal 120 in the circuit simulation system shown in FIG. 1. As shown in FIG. 2, the circuit simulation method may include the following steps.

Step 201: Obtain sub-circuit modules in a target circuit.

Optionally, the target circuit is formed by the sub-circuit modules. Each sub-circuit module may generate a corresponding output circuit signal based on an input circuit signal.

For example, in one complete target circuit, to ensure that the target circuit can normally implement a function, the target circuit usually includes sub-circuit modules having different functions, for example, an oscillator circuit, or an optocoupler circuit. Each sub-circuit module may generate a corresponding signal (for example, an oscillator may output a clock signal with a specified frequency) based on an input signal (for example, an input voltage).

Step 202: Perform function fitting processing on the sub-circuit modules to obtain fitting functions corresponding to the sub-circuit modules.

After a sub-circuit module is obtained, the sub-circuit module may generate a corresponding output signal based on an input circuit signal, similar to the definition of a function. Therefore, based on a relationship between the input signal and the output signal of the sub-circuit module, a fitting function corresponding to the sub-circuit module may be obtained through fitting. An independent variable of the fitting function is the input signal of the circuit, and a dependent variable of the fitting function is the output signal of the circuit.

Step 203: Replace, based on a logical relationship among the sub-circuit modules, the target circuit with the fitting functions respectively corresponding to the sub-circuit modules for simulation processing to obtain a simulation result of the target circuit.

The sub-circuit modules in the target circuit have a certain logical relationship. For example, a clock signal generated by an oscillator circuit may be inputted into some sub-circuit modules that require a clock signal, and is used as an input signal of the sub-circuit modules that require a clock signal. Therefore, based on the logical relationship among the sub-circuit modules, processing is performed sequentially based on the fitting functions respectively corresponding to the sub-circuit modules, so that a corresponding simulation result of the target circuit may be obtained.

In summary, when simulation needs to be performed on a target circuit, the target circuit may be first divided into sub-circuit modules, and fitting is performed on the sub-circuit modules by using fitting functions, to implement representation of circuit characteristics of the sub-circuit modules by using the fitting functions. After the fitting functions corresponding to the sub-circuit modules in the target circuit are obtained, based on a logical relationship among the sub-circuit modules, the target circuit is replaced with the fitting functions corresponding to the sub-circuit modules to perform simulation, a target circuit matrix with complex data does not need to be constructed, and the simulation efficiency of the circuit is improved.

FIG. 3 is a method flowchart of a circuit simulation method according to an exemplary embodiment. The method is performed by an electronic device. The electronic device may be the server 110 in the circuit simulation system shown in FIG. 1 or the terminal 120 in the circuit simulation system shown in FIG. 1. As shown in FIG. 3, the circuit simulation method may include the following steps.

Step 301: Obtain sub-circuit modules in a target circuit.

In a possible implementation, when needing to perform simulation on the target circuit, the electronic device may first obtain the sub-circuit modules in the target circuit. The sub-circuit modules may be stored in the electronic device in advance.

In another possible implementation, the electronic device have a circuit design client. When receiving a specified operation on the circuit design client, the electronic device obtains sub-circuit modules corresponding to the specified operation.

That is, the target circuit is obtained by combining sub-circuit modules designed by a designer. When needing to generate the target circuit by using the circuit design client, the designer may first generate some circuits (that is, sub-circuit modules) in the target circuit by using the circuit design client.

Step 302: Obtain a simulation result of each of the sub-circuit modules.

In a possible implementation, the simulation result of the sub-circuit module may be stored in the electronic device in advance. Alternatively, the simulation result of the sub-circuit module and the sub-circuit module may be simultaneously transmitted to the electronic device.

That is, after the sub-circuit module is generated in another device, simulation processing may be performed by using simulation software to obtain the simulation result of the sub-circuit module, and is transmitted to the electronic device by using the another device.

In a possible implementation, the electronic device constructs an operation matrix corresponding to the sub-circuit module based on circuit parameters in the sub-circuit module, and obtains the simulation result corresponding to the sub-circuit module by using the operation matrix corresponding to the sub-circuit module.

For example, after the operation matrix corresponding to the sub-circuit module is obtained, operation may be performed on preset input values by using the operation matrix to obtain an output value of the operation matrix. The output value is the simulation result of the sub-circuit module.

Step 303: When a confirmation operation for the simulation result of any one of the sub-circuit modules is received, perform the function fitting processing on this one of the sub-circuit modules to obtain the fitting function corresponding to this one of the sub-circuit modules.

When a confirmation operation for the simulation result of the sub-circuit module is received, it indicates that the simulation result of the sub-circuit module satisfies the expectations of the designer. Therefore, the sub-circuit module is a correctly designed circuit. The circuit no longer needs adjustment. In this case, function fitting processing may be directly performed on the sub-circuit module to obtain a fitting function of the sub-circuit module.

In a possible implementation, sub-circuit parameters in the sub-circuit module are obtained, and a sub-circuit matrix corresponding to the sub-circuit module is constructed based on the sub-circuit parameters. Sample input data is processed based on the sub-circuit matrix to obtain predicted output data corresponding to the sample input data. Fitting is performed by using a linear regression method based on the sample input data and the predicted output data corresponding to the sample input data to obtain the fitting function corresponding to the sub-circuit module.

When the sub-circuit parameters in the sub-circuit module are obtained, the sub-circuit parameters may be constructed as the sub-circuit matrix corresponding to the sub-circuit module. In this case, the sub-circuit matrix is used for indicating circuit characteristics of the sub-circuit module. When the sample input data is inputted into the sub-circuit matrix and linear operation is performed, the obtained predicted output data may be considered as output data that may be generated after the sub-circuit module receives electric data corresponding to the sample input data.

For the sub-circuit module, when receiving the same input data, the sub-circuit module generates the same output data in response. Therefore, if input data is considered as an independent variable, the output data is a dependent variable corresponding to the independent variable. This satisfies the definition of a function. Therefore, fitting may be performed on the circuit characteristics of the sub-circuit module by using a function.

When fitting processing needs to be performed on the circuit characteristics of the sub-circuit module by using a function, a plurality of pieces of sample input data may be respectively inputted into the sub-circuit matrix as independent variables to obtain predicted output data (that is, dependent variables) respectively corresponding to the pieces of sample input data, and fitting is performed by using a linear regression method based on a correspondence between the independent variables and the dependent variables to obtain the fitting function corresponding to the sub-circuit module.

When a user performs simulation on a circuit, it is in fact to determine an output value of a specified parameter of the circuit in a determination state. For example, when the user performs simulation on a circuit, it may be necessary to determine an input voltage of a first component and a current of a first branch corresponding to the first component in the circuit. A simulation result that needs to be obtained when the user performs simulation on the circuit may be a current of a second branch in the circuit measured by an ammeter when the input voltage of the first component is determined and the current of the first branch is determined.

Therefore, when simulation processing is performed on a circuit, it may be necessary to input a plurality of independent variables. In this case, a dependent variable may change as the plurality of independent variables change. Therefore, in a possible implementation, a quantity of items in the fitting function is determined based on a type of the sample input data of the sub-circuit module, and a regression function of a linear function type is constructed based on the quantity of items in the fitting function. The regression function is iteratively updated by using a least squares method based on the sample input data and the predicted output data corresponding to the sample input data to obtain the fitting functions corresponding to the sub-circuit modules.

For example, a method for iteratively updating the fitting function may include the following steps:
(1) When a quantity of types of inputted parameters is N, it is determined that a quantity of independent variables X is N. Therefore, a formula of an output value of the first sub-circuit module, that is, a dependent variable Y is as follows:

Y=A₀+A₁X₁+A₂X₂+ . . . +AₙXₙ+e.

where e in the formula is an error value, and A₀, A₁, A₂, . . . , Aₙ are a to-be-estimated regression coefficient.
(2) It is assumed that p groups of observed values (Xᵢ₁, Xᵢ₂, . . . , Xᵢₙ, Yᵢ) (i=1, 2, p) of the dependent variable Y and independent variables X₁, X₂, . . . , Xₙ satisfy:

Yᵢ=A₀+A₁Xᵢ₁+A₂Xᵢ₂+ . . . +AₙXᵢₙ+ei.

In addition, it is assumed that ei satisfies Gauss-Markov assumption, that is, an expected value of the error value is zero, a covariance of the error value is zero, for different independent variables, variances of the error values are equal, and the error values meet normal distribution.
(3) To eliminate differences in units and value ranges and facilitate statistical analysis of estimated values of the regression coefficient, original data of the independent variable X is standardized.
(4) A least squares estimate of a group of regression coefficients is found, to minimize a residual sum of squares of a regression model.
(5) A variance and a standard deviation of least squares estimates of the regression coefficients is calculated.
(6) Estimates of the regression coefficients, a variance and a standard deviation of the regression coefficients, and a confidence interval of the regression coefficients are calculated, to obtain an initial linear regression model.
(7) A regression coefficient significance test, a regression equation linear relationship significance test, and a model structure stability test are performed on the initial linear regression model to obtain a final linear regression model.

In a possible implementation, to avoid overfitting or underfitting of a fitting function obtained through iterative update by using the foregoing steps, the fitting function corresponding to the sub-circuit module may be verified by verifying input data and verifying output data. When verification succeeds, the fitting function corresponding to the sub-circuit module is stored. When verification fails, the fitting function is updated to a nonlinear function in a variable replacement manner, and iterative update is performed again by using a least squares method based on the sample input data and the predicted output data to obtain an updated fitting function corresponding to the sub-circuit module.

In addition to a linear device such as a conventional resistor in the circuit, there may further be a nonlinear device such as a bipolar junction transistor. Therefore, good fitting may fail to be performed on the circuit characteristics of the sub-circuit module by using a linear function. In this case, a fitting function of a linear function type may be converted into a nonlinear function in a variable replacement manner.

For example, a process of converting a fitting function of a linear function type into a fitting function of a nonlinear function type may be as follows:
(1) A dependent variable and an independent variable are converted, so that two converted variables have a linear relationship (for example, variable replacement is performed by using a logarithmic function). Next, fitting is performed on the converted linear equation between the independent variable and the dependent variable by using a least squares method. Then, variables in the obtained linear equation are restored to obtain a response curve equation, that is, to obtain initial values of regression coefficients in the model.

If the curve cannot be directly linearized, one or two regression coefficients within small change ranges are first selected. A cyclic variable is set to make the regression coefficient change within a small possible range based on a certain step size. In each cycle, these regression coefficients have specific values. After variable conversion is performed on a curve model, linear regression analysis is performed, and then variables in the obtained linear equation are restored to obtain a response curve equation, that is, to obtain an initial value of the regression coefficient in the model.
(2) A group of values are found within a regression coefficient range to minimize a residual sum of squares of actual data in fitting of the model, to obtain an estimate of the regression coefficient, thereby obtaining a corresponding nonlinear regression model.
(3) The regression model is stored corresponding to the first sub-circuit module in a form of a functional expression.

In a possible implementation, an input data range corresponding to the sub-circuit matrix is obtained; and sampling is performed within the input data range corresponding to the sub-circuit matrix to obtain the sample input data.

After the designer designs the sub-circuit module, a normal operating range corresponding to the sub-circuit module may further be determined. That is, the sub-circuit module may show normal circuit characteristics within the normal operating range. In this case, when receiving an input data range corresponding to a sub-circuit module inputted by the designer, the electronic device stores the input data range in the data memory of the electronic device. When producing a sub-circuit matrix based on parameters of the sub-circuit module, the electronic device uses the input data range corresponding to the sub-circuit module as the input data range of the sub-circuit matrix, and performs sampling in the input data range of the sub-circuit matrix to obtain the sample input data.

In a possible implementation, a matrix order corresponding to the sub-circuit matrix is obtained; and sample input data of a specified quantity is obtained based on the matrix order of the sub-circuit matrix.

Because the matrix order of the sub-circuit matrix represents the complexity of the sub-circuit matrix. A more complex sub-circuit matrix requires fitting of more sample input data and predicted output data, to ensure the accuracy of the function obtained through fitting by the sub-circuit module. Therefore, when the matrix order of the sub-circuit matrix is larger, a specified quantity of the sample input data is larger.

In a possible implementation, a matrix order corresponding to the sub-circuit matrix is obtained; and the input data range is equally divided based on the matrix order of the sub-circuit matrix, and data values obtained by the equal dividing are determined as the sample input data.

After the matrix order corresponding to the sub-circuit matrix is obtained, the input data range is equally divided based on the matrix order, and data values obtained by the equal dividing are determined as the sample input data. In this case, data in the input data range is sampled more evenly as the sample input data. Therefore, the overall status of the input data range is considered for the sample input data, and the sample input data is obtained by the equally dividing and sampling, so that the accuracy of a function obtained through fitting is improved.

Step 304: Replace, based on a logical relationship among the sub-circuit modules, the target circuit with the fitting functions respectively corresponding to the sub-circuit modules for simulation processing to obtain a simulation result of the target circuit.

In a possible implementation, input data corresponding to an i^{th} sub-circuit module is processed by using a fitting function corresponding to the i^{th} sub-circuit module to obtain output data corresponding to the i^{th} sub-circuit module, where the i^{th} sub-circuit module and an (i+1)^{th} sub-circuit module have a logical connection relationship; and

the output data corresponding to the i^{th} sub-circuit module is processed as input data corresponding to the (i+1)^{th} sub-circuit module by using a fitting function corresponding to the (i+1)^{th} sub-circuit module to obtain output data corresponding to the (i+1)^{th} sub-circuit module.

After the fitting functions corresponding to the sub-circuit modules in the target circuit are obtained, a logical relationship among the sub-circuit modules in the target circuit may be determined first. For example, a logical connection relationship exists between the i^{th} sub-circuit module and the (i+1)^{th} sub-circuit module, and an output value of the i^{th} sub-circuit module may be used as an input value of the (i+1)^{th} sub-circuit module.

In this case, when simulation needs to be performed on the target circuit, based on the logical connection relationship, a sub-circuit module ranking higher in the logical connection relationship may first generate a corresponding output value by using a fitting function, then the output value is used as an input value of a sub-circuit module ranking lower in the logical connection relationship, and calculation is performed by using a fitting function of the sub-circuit module ranking lower to obtain an output value of the sub-circuit module ranking lower.

An output result of a fitting function of each sub-circuit module in the target circuit obtained by using the foregoing process is the simulation result of the target circuit.

When needing to perform simulation on the target circuit, for example, perform simulation on current characteristics in the target circuit, the designer may sequentially obtain characteristic parameter values of the sub-circuit modules in the target circuit by using the foregoing process, and use an output current of a target sub-circuit module (for example, the last sub-circuit module) in each sub-circuit module as the simulation result of the target circuit.

Optionally, when simulation is performed on the target circuit and the target circuit involves a plurality of circuit characteristics, fitting functions that respectively correspond to the plurality of characteristics of each sub-circuit module in the target circuit may be obtained through fitting, and then each characteristic value of each sub-circuit module is outputted based on the fitting functions that respectively correspond to the plurality of characteristics of each sub-circuit module, to implement simulation of the target circuit.

For example, when simulation is performed on the target circuit, the target circuit includes a first sub-circuit module and a second sub-circuit module. In this case, an output of the second sub-circuit module may be susceptible to both an input current and an input voltage. Therefore, when a simulation operation is performed on the second sub-circuit module to obtain an output of the second sub-circuit module, both a current outputted by the first sub-circuit module and a voltage outputted by the first sub-circuit module need to be considered.

Therefore, current-based function fitting needs to be first performed on the first sub-circuit module by using the solution in the embodiments of this application to obtain a current fitting function corresponding to the first sub-circuit module. Then voltage-based function fitting is performed on the first sub-circuit module to obtain a voltage fitting function corresponding to the first sub-circuit module. In this case, for the first sub-circuit module, processing may be performed based on an input of the first sub-circuit module by using the current fitting function and the voltage fitting function to respectively obtain an output current and an output voltage of the first sub-circuit module, which are used as input data of the second sub-circuit module, thereby implementing a simulation process of the second sub-circuit module in the target circuit.

In summary, when simulation needs to be performed on a target circuit, the target circuit may be first divided into sub-circuit modules, and fitting is performed on the sub-circuit modules by using fitting functions, to implement representation of circuit characteristics of the sub-circuit modules by using the fitting functions. After the fitting functions corresponding to the sub-circuit modules in the target circuit are obtained, based on a logical relationship among the sub-circuit modules, the target circuit is replaced with the fitting functions corresponding to the sub-circuit modules to perform simulation, a target circuit matrix with complex data does not need to be constructed, and the simulation efficiency of the circuit is improved.

In addition, function fitting processing of the sub-circuit modules need to consume a large number of computing resources. In the embodiments of this application, when receiving the confirmation operation for the simulation result of the sub-circuit module, function fitting processing is performed on the sub-circuit module. Therefore, a function fitting processing process of a sub-circuit module in a target circuit is separate, to avoid that function fitting processing needs to be simultaneously performed on a large number of sub-circuit modules when simulation is performed on the target circuit, thereby improving the efficiency of simulation processing of the target circuit.

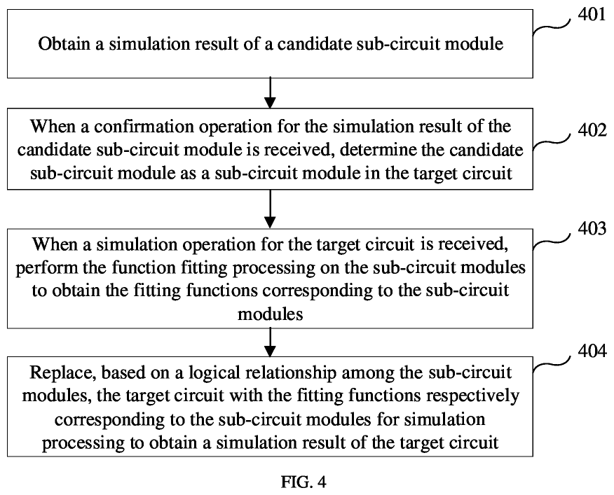

FIG. 4 is a method flowchart of a circuit simulation method according to an exemplary embodiment. The method is performed by an electronic device. The electronic device may be the server 110 in the circuit simulation system shown in FIG. 1 or the terminal 120 in the circuit simulation system shown in FIG. 1. As shown in FIG. 4, the circuit simulation method may include the following steps.

Step 401: Obtain a simulation result of a candidate sub-circuit module.

The candidate sub-circuit module is an unverified sub-circuit module for the target circuit.

Optionally, when designing the target circuit, a designer may first design a candidate sub-circuit module in the target circuit. After simulated verification of the candidate sub-circuit module succeeds, the candidate sub-circuit module is stored. When simulation verification of the candidate sub-circuit module fails, it represents that the candidate sub-circuit module further need to be redesigned.

Step 402: When a confirmation operation for the simulation result of the candidate sub-circuit module is received, determine the candidate sub-circuit module as a sub-circuit module in the target circuit.

When a confirmation operation for the simulation result of the candidate sub-circuit module is received, it indicates that in this case the designer approves of the simulation result of the candidate sub-circuit module. The candidate sub-circuit module has circuit performance that satisfies expectations. Therefore, the candidate sub-circuit module may be determined as a sub-circuit module in the target circuit.

Step 403: When a simulation operation for the target circuit is received, perform the function fitting processing on the sub-circuit modules to obtain the fitting functions corresponding to the sub-circuit modules.

When all sub-circuit modules in the target circuit have been designed and a simulation operation for the target circuit is received, the function fitting processing may be performed on the sub-circuit modules to obtain the fitting functions corresponding to the sub-circuit modules.

For the foregoing function fitting processing process, refer to steps 303 in the embodiment shown in FIG. 4. Details are not described herein again.

Step 404: Replace, based on a logical relationship among the sub-circuit modules, the target circuit with the fitting functions respectively corresponding to the sub-circuit modules for simulation processing to obtain a simulation result of the target circuit.

For the simulation processing process, refer to steps 304 in the embodiment shown in FIG. 3. Details are not described herein again.

In summary, when simulation needs to be performed on a target circuit, the target circuit may be first divided into sub-circuit modules, and fitting is performed on the sub-circuit modules by using fitting functions, to implement representation of circuit characteristics of the sub-circuit modules by using the fitting functions. After the fitting functions corresponding to the sub-circuit modules in the target circuit are obtained, based on a logical relationship among the sub-circuit modules, the target circuit is replaced with the fitting functions corresponding to the sub-circuit modules to perform simulation, a target circuit matrix with complex data does not need to be constructed, and the simulation efficiency of the circuit is improved.

In addition, function fitting of the sub-circuit modules need to consume a large number of computing resources. In the embodiments of this application, to keep the operation of the terminal and the server from being affected due to occupation of resources of the terminal or the server in a function fitting processing process, a function fitting processing process is performed only when a simulation operation for the target circuit is received, so that while normal implementation of the simulation operation of the target circuit is ensured, adverse impact of the function fitting processing on the occupation of resources of the terminal or the server is avoided.

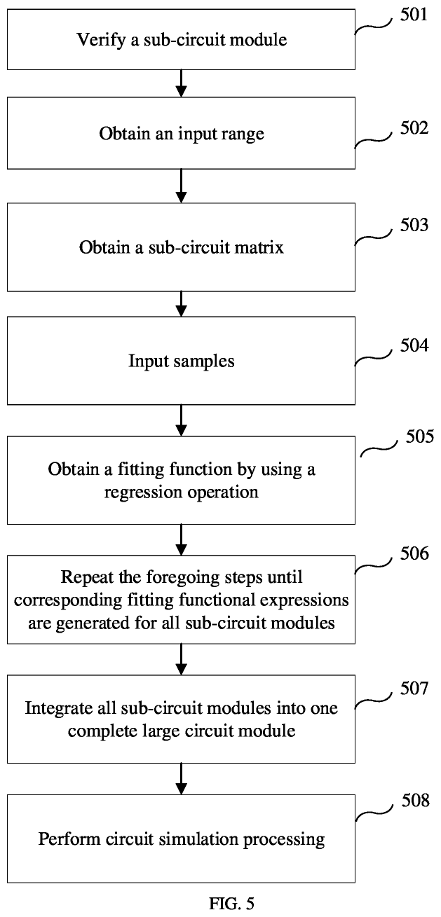

FIG. 5 is a schematic flowchart of a circuit design and a circuit simulation method according to an exemplary embodiment. In a process of designing a circuit by a circuit designer or after design of a circuit is completed, simulation processing of the circuit may be implemented by using the solution in the embodiments of this application. The solution in the embodiments of this application includes the following steps.

Step 501: Verify a sub-circuit module.

After completing the design of a first sub-circuit module, the circuit designer performs simulated verification on the first sub-circuit module by using simulation software. When a simulation result satisfies expectations of the circuit designer, the circuit designer clicks a simulation completion confirmation button in the simulation software.

When one complete large circuit needs to be designed, the circuit designer usually divides the large circuit into a plurality of sub-circuit modules, and sequentially designs the plurality of sub-circuit module. In addition, the circuit designer needs to finish simulated verification of the correctness of a sub-circuit module being designed before designing a next sub-circuit module.

Step 502: Obtain an input range.

After the simulation software identifies an operation of clicking the simulation completion confirmation button, the last first sub-circuit module on which simulation is performed is automatically stored. In addition, the circuit designer enters upper limit values and lower limit values of inputs of the first sub-circuit module.

After the simulation software identifies the operation of clicking the simulation completion confirmation button, the software determines by default that the circuit designer believes that the last first sub-circuit module on which simulation is performed is correct. Therefore, the last first sub-circuit module on which simulation is performed is automatically stored in a netlist file.

In addition, the simulation software pops up an input box. The circuit designer inputs, in the input box based on an actual status of the first sub-circuit module, a type of a parameter that needs to be inputted at each input end of the first sub-circuit module and upper limit values and lower limit values of the parameters.

Step 503: Obtain a sub-circuit matrix.

The first sub-circuit module is represented in a matrix form.

The first sub-circuit module is represented in a matrix form by using a loop current method, a node voltage method, a cut set voltage method or a list method.

Step 504: Input samples.

A plurality of sampling points are set. That is, a plurality of circuit input values are inputted, and are introduced into the matrix for calculation to obtain output values of a plurality of first sub-circuit modules.
(1) A matrix order of a first sub-circuit module is identified. For example, a matrix with m rows and n columns is an m*n matrix. An order of a matrix is correlated with a node quantity, a branch quantity, and the like of the first sub-circuit module. A quantity of sampling points is designed to be positively correlated with the order. That is, when the order is higher, more sampling points are set. Specifically, for example, when the matrix is a matrix of 3*4 order, the quantity of sampling points may be designed to be a multiple of 12. When the multiple is larger, simulation precision is higher.
(2) The upper limit values and the lower limit values of the parameters are inputted into the matrix of the first sub-circuit module, and at the same time equal dividing is performed between the upper limit values and the lower limit values of the parameters. Values of the equal dividing are inputted, and a quantity of the equal dividing is designed to make a quantity of inputted parameters equal to a quantity of sampling points. For example, 48 sampling points need to be acquired, and a quantity of parameters that need to be inputted is designed to be 48. The inputted parameters are introduced into the matrix to perform calculation to obtain outputs of the plurality of first sub-circuit modules, and inputted values of the parameters and the output values of the plurality of first sub-circuit modules are stored in a one-to-one correspondence to obtain a plurality of sampling points.

Step 505: Obtain a fitting function by using a regression operation.

The plurality of circuit input values are used as independent variables and the output values of the first sub-circuit module are used dependent variables to perform regression operation, and fitting is performed to obtain an alternative curve, that is, fitting is performed to obtain a fitting functional expression.

Step 506: Repeat the foregoing steps until corresponding fitting functional expressions are generated for all sub-circuit modules.

Every time a developer completes the design of one sub-circuit module, the simulation software automatically generates a fitting functional expression corresponding to the sub-circuit module, until the design of all sub-circuit modules is completed and corresponding fitting functional expressions are automatically generated.

Step 507: Integrate all sub-circuit modules into one complete large circuit module.

After the design of all sub-circuit modules is completed, to verify the correctness of the circuit, the sub-circuit modules need to be integrated in the simulation software into one complete large circuit module, to facilitate subsequent simulated verification.

Step 508: Perform circuit simulation processing.

The circuit designer clicks a quick simulation button in the simulation software. The simulation software replaces all the sub-circuit modules with fitting functional expressions to perform quick simulation, to quickly obtain a simulation result.

When the circuit designer performs simulation on the complete large circuit module, to obtain an accurate result, simulation may be performed in the most common simulation method. However, this simulation method is very time consuming, and often takes several hours or even several days. If the circuit designer only intends to verify the correctness of the circuit to see a trend of output values of the circuit, the circuit designer may click the quick simulation button. The simulation software replaces all the sub-circuit modules with fitting functional expressions to perform simulation to quickly obtain a simulation result. While simulation precision is appropriately reduced, the speed of simulation is greatly improved.

It should be noted that in the solution in the embodiments of this application, function fitting is performed on outputs generated by circuits in response to a state, and a fitting function obtained through fitting is also performing processing on a state to obtain output values of the circuits in the state. Therefore, the foregoing solution is used in a simulation process of direct current analysis.

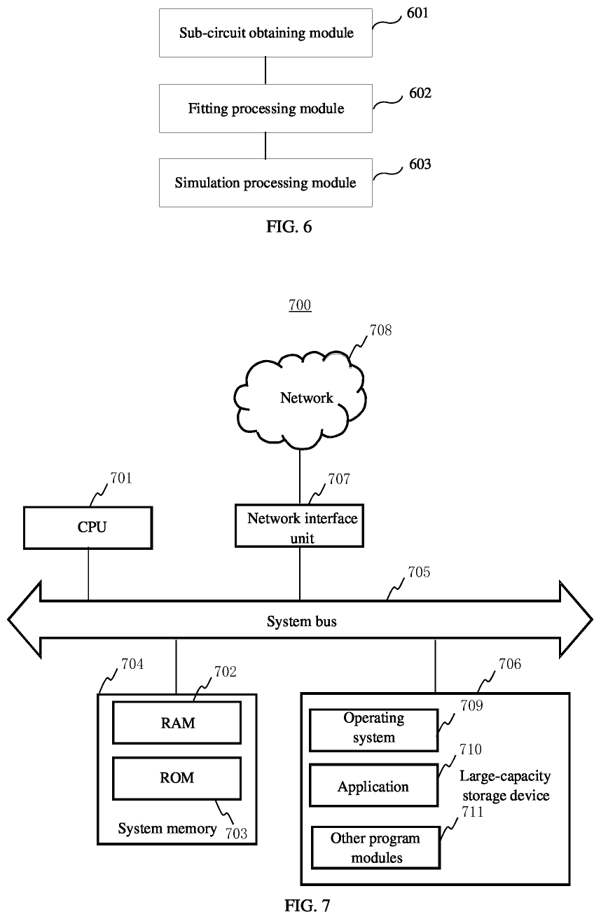

FIG. 6 is a structural block diagram of a circuit simulation apparatus according to an exemplary embodiment. The circuit simulation apparatus includes:
a sub-circuit obtaining module 601, configured to obtain sub-circuit modules in a target circuit;
a fitting processing module 602, configured to perform function fitting processing on the sub-circuit modules to obtain fitting functions corresponding to the sub-circuit modules; and
a simulation processing module 603, configured to replace, based on a logical relationship among the sub-circuit modules, the target circuit with the fitting functions respectively corresponding to the sub-circuit modules for simulation processing to obtain a simulation result of the target circuit.

In a possible implementation, the fitting processing module includes:
a simulation result obtaining unit, configured to obtain a simulation result of each of the sub-circuit modules; and
a fitting function obtaining unit, configured to: when a confirmation operation for the simulation result of any one of the sub-circuit modules is received, perform the function fitting processing on this one of the sub-circuit modules to obtain the fitting function corresponding to this one of the sub-circuit modules.

In a possible implementation, the sub-circuit obtaining module includes:
a candidate simulation obtaining module, configured to obtain a simulation result of a candidate sub-circuit module, where the candidate sub-circuit module is an unverified sub-circuit module for the target circuit; and
a sub-circuit determining module, configured to: when a confirmation operation for the simulation result of the candidate sub-circuit module is received, determine the candidate sub-circuit module as a sub-circuit module in the target circuit; and
the fitting processing module is further configured to:
when a simulation operation for the target circuit is received, perform the function fitting processing on the sub-circuit modules to obtain the fitting functions corresponding to the sub-circuit modules.

In a possible implementation, the fitting processing module is further configured to:
obtain sub-circuit parameters of each of the sub-circuit modules, and construct, based on the sub-circuit parameters, a sub-circuit matrix corresponding to each of the sub-circuit modules;
process sample input data based on the sub-circuit matrix to obtain predicted output data corresponding to the sample input data; and
perform fitting by using a linear regression method based on the sample input data and the predicted output data corresponding to the sample input data to obtain the fitting function corresponding to each of the sub-circuit modules.

In a possible implementation, the fitting processing module further includes:
a data range obtaining unit, configured to obtain an input data range corresponding to the sub-circuit matrix; and
an input data sampling unit, configured to perform sampling within the input data range corresponding to the sub-circuit matrix to obtain the sample input data.

In a possible implementation, the input data obtaining unit further includes:
a matrix order obtaining sub-unit, configured to obtain a matrix order corresponding to the sub-circuit matrix; and
an input data obtaining sub-unit, configured to: equally divide the input data range based on the matrix order of the sub-circuit matrix, and determine data values obtained by the equal dividing as the sample input data.

In a possible implementation, the simulation processing module includes:
a first output unit, configured to process input data corresponding to an i^{th} sub-circuit module by using a fitting function corresponding to the i^{th} sub-circuit module to obtain output data corresponding to the i^{th} sub-circuit module, where the i^{th} sub-circuit module and an (i+1)^{th} sub-circuit module have a logical connection relationship; and
a second output unit, configured to process, by using a fitting function corresponding to the (i+1)^{th} sub-circuit module, the output data corresponding to the i^{th} sub-circuit module as input data corresponding to the (i+1)^{th} sub-circuit module to obtain output data corresponding to the (i+1)^{th} sub-circuit module.

In summary, when simulation needs to be performed on a target circuit, the target circuit may be first divided into sub-circuit modules, and fitting is performed on the sub-circuit modules by using fitting functions, to implement representation of circuit characteristics of the sub-circuit modules by using the fitting functions. After the fitting functions corresponding to the sub-circuit modules in the target circuit are obtained, based on a logical relationship among the sub-circuit modules, the target circuit is replaced with the fitting functions corresponding to the sub-circuit modules to perform simulation, a target circuit matrix with complex data does not need to be constructed, and the simulation efficiency of the circuit is improved.

FIG. 7 is a structural block diagram of an electronic device 700 according to an exemplary embodiment of this application. The electronic device may be implemented as a server in the foregoing solution of this application. The electronic device 700 includes a central processing unit (CPU) 701, a system memory 704 including a random access memory (RAM) 702 and a read-only memory (ROM) 703, and a system bus 705 connecting the system memory 704 and the CPU 701. The server 700 further includes a large-capacity storage device 706 configured to store an operating system 709, applications 710, and other program modules 711.

The large-capacity storage device 706 is connected to the CPU 701 by a large-capacity storage controller (not shown) connected to the system bus 705. The large-capacity storage device 706 and a computer-readable medium related thereto may provide non-volatile storage to the electronic device 700. That is, the large-capacity storage device 706 may include a computer-readable medium (not shown) such as a hard disk or a compact disc read-only memory (CD-ROM) drive.

Without loss of generality, the computer-readable medium may include a computer storage medium and a communication medium. The computer storage medium includes volatile and non-volatile, removable and non-removable media that are implemented by any method or technology and are configured to store information such as computer-readable instructions, data structures, program modules or other data. The computer storage medium includes a RAM, a ROM, an erasable programmable read-only memory (EPROM), an electrically erasable programmable read-only memory (EEPROM), a flash memory or other solid state storage technologies, a CD-ROM, a digital versatile disc (DVD) or other optical storages, a cassette tape, a tape, a disk storage or other magnetic storage devices. Certainly, a person skilled in the art can understand that the computer storage medium is not limited to the above types. The foregoing system memory 704 and the large-capacity storage device 706 may be generally referred to as memories.

According to various embodiments of this application, the electronic device 700 may further be connected, by a network such as the Internet, to a remote computer on the network for operation. That is, the electronic device 700 may be connected to a network 708 by a network interface unit 707 connected to the system bus 705, or in other words, may be connected to other types of networks or remote computer systems (not shown) by using the network interface unit 707.

The memory further includes at least one computer program. The at least one computer program is stored in the memory. The CPU 701 implements all or some of the steps in the method shown in each of the foregoing embodiments by executing the at least one computer program.

In an exemplary embodiment, a computer-readable storage medium is further provided, and configured to store at least one computer program. The at least one computer program is loaded and executed by the processor to implement all or some of the steps in the foregoing method. The computer-readable storage medium may be, for example, a ROM, a RAM, a CD-ROM, a magnetic tape, a floppy disk or an optical data storage device.

In an exemplary embodiment, a computer program product or a computer program is further provided. The computer program product or the computer program includes computer instructions. The computer instructions are stored in a computer-readable storage medium. A processor of an electronic device reads the computer instructions from the computer-readable storage medium. The processor executes the computer instructions, so may be electronic device is enabled to perform all or some of the steps of the foregoing method in any embodiment in FIG. 2 or FIG. 3.

A person skilled in the art can easily figure out another implementation solution of this application after considering this specification and practicing the invention that is disclosed herein. This application is intended to cover any variations, functions, or adaptive changes of this application. These variations, functions, or adaptive changes comply with general principles of this application, and include common knowledge or a commonly used technical means in the technical field that is not disclosed in this application. The Description and the embodiments are to be regarded as being exemplary only. The true scope and spirit of this application are subject to the following claims.

It will be appreciated that this application is not limited to the exact construction that has been described above and illustrated in the accompanying drawings, and that various modifications and changes can be made without departing from the scope thereof. It is intended that the scope of this application only be limited by the appended claims.

What is claimed is:

1. A circuit simulation method, wherein the method comprises:
obtaining sub-circuit modules in a target circuit;
performing function fitting processing on the sub-circuit modules to obtain fitting functions corresponding to the sub-circuit modules; and
replacing, based on a logical relationship among the sub-circuit modules, the target circuit with the fitting functions respectively corresponding to the sub-circuit modules for simulation processing to obtain a simulation result of the target circuit.

2. The method according to claim 1, wherein the step of performing function fitting processing on the sub-circuit modules to obtain fitting functions corresponding to the sub-circuit modules comprises:
obtaining a simulation result of each of the sub-circuit modules; and
when a confirmation operation for the simulation result of any one of the sub-circuit modules is received, performing the function fitting processing on this one of the sub-circuit modules to obtain the fitting function corresponding to this one of the sub-circuit modules.

3. The method according to claim 1, wherein the step of obtaining sub-circuit modules in a target circuit comprises:
obtaining a simulation result of a candidate sub-circuit module, wherein the candidate sub-circuit module is an unverified sub-circuit module for the target circuit; and
when a confirmation operation for the simulation result of the candidate sub-circuit module is received, determining the candidate sub-circuit module as a sub-circuit module in the target circuit; and
the step of performing function fitting processing on the sub-circuit modules to obtain fitting functions corresponding to the sub-circuit modules comprises:
when a simulation operation for the target circuit is received, performing the function fitting processing on the sub-circuit modules to obtain the fitting functions corresponding to the sub-circuit modules.

4. The method according to claim 1, wherein the step of performing function fitting processing on the sub-circuit modules to obtain fitting functions corresponding to the sub-circuit modules comprises:
obtaining sub-circuit parameters of each of the sub-circuit modules, and constructing, based on the sub-circuit parameters, a sub-circuit matrix corresponding to each of the sub-circuit modules;
processing sample input data based on the sub-circuit matrix to obtain predicted output data corresponding to the sample input data; and
performing fitting by using a linear regression method based on the sample input data and the predicted output data corresponding to the sample input data to obtain the fitting function corresponding to each of the sub-circuit modules.

5. The method according to claim 4, wherein, before the step of processing sample input data based on the sub-circuit matrix to obtain predicted output data corresponding to the sample input data, the method further comprises:
obtaining an input data range corresponding to the sub-circuit matrix; and
performing sampling within the input data range corresponding to the sub-circuit matrix to obtain the sample input data.

6. The method according to claim 5, wherein the step of performing sampling within the input data range corresponding to the sub-circuit matrix to obtain the sample input data comprises:
obtaining a matrix order corresponding to the sub-circuit matrix; and
equally dividing the input data range based on the matrix order of the sub-circuit matrix, and determining data values obtained by the equal dividing as the sample input data.

7. The method according to claim 1, wherein the step of replacing, based on a logical relationship among the sub-circuit modules, the target circuit with the fitting functions respectively corresponding to the sub-circuit modules for simulation processing to obtain a simulation result of the target circuit comprises:
processing input data corresponding to an i^{th} sub-circuit module by using a fitting function corresponding to the i^{th} sub-circuit module to obtain output data corresponding to the i^{th} sub-circuit module, wherein the i^{th} sub-circuit module and an (i+1)^{th} sub-circuit module have a logical connection relationship; and
processing, by using a fitting function corresponding to the (i+1)^{th} sub-circuit module, the output data corresponding to the i^{th} sub-circuit module as input data corresponding to the (i+1)^{th} sub-circuit module to obtain output data corresponding to the (i+1)^{th} sub-circuit module.

8. A circuit simulation apparatus, wherein the apparatus comprises:
a sub-circuit obtaining module, configured to obtain sub-circuit modules in a target circuit;
a fitting processing module, configured to perform function fitting processing on the sub-circuit modules to obtain fitting functions corresponding to the sub-circuit modules; and
a simulation processing module, configured to replace, based on a logical relationship among the sub-circuit modules, the target circuit with the fitting functions respectively corresponding to the sub-circuit modules for simulation processing to obtain a simulation result of the target circuit.

9. An electronic device, wherein the electronic device comprises a processor and a memory, the memory stores at least one instruction, and the at least one instruction is configured to be loaded and executed by the processor to implement the circuit simulation method according to claim 1.

10. (canceled)
